(19) United States
(12) Patent Application Publication
(10) Pub. No.: US 2024/0273357 A1
(43) Pub. Date: Aug. 15, 2024

(54) EVALUATION METHOD, EVALUATION APPARATUS, AND NON-TRANSITORY COMPUTER-READABLE STORAGE MEDIUM

(71) Applicant: SEIKO EPSON CORPORATION, TOKYO (JP)

(72) Inventors: Yuki URUSHIBATA, SHIOJIRI-SHI (JP); Ryoki WATANABE, Matsumoto-shi (JP); Hikaru KURASAWA, Matsumoto-shi (JP)

(21) Appl. No.: 18/438,534

(22) Filed: Feb. 12, 2024

(30) Foreign Application Priority Data
Feb. 14, 2023 (JP) 2023-021039

(51) Int. Cl. G06N 3/08

(52) U.S. Cl. CPC G06N 3/08

(57) ABSTRACT

An evaluation method for evaluating target data includes: inputting a plurality of training sets to a vector neural network machine learning model having a plurality of vector neuron layers to train the machine learning model, the training sets including of general-purpose training data having a type different from the target data and a label corresponding to the general-purpose training data; acquiring a reference feature spectrum; acquiring a target feature spectrum; calculating a spectral similarity that is a similarity between the reference feature spectrum and the target feature spectrum; and evaluating the target data using the spectral similarity.

The present application is based on, and claims priority from JP Application Serial Number 2023-021039, filed Feb. 14, 2023, the disclosure of which is hereby incorporated by reference herein in its entirety.

### BACKGROUND

### 1. Technical Field

The present disclosure relates to a technique for evaluating target data.

### 2. Related Art

In the related art, a vector neural network machine learning model having a plurality of vector neuron layers is known (JP-A-2022-56611). In the trained machine learning model, a spectral similarity is calculated by comparing an understood feature spectrum that is an evaluation reference with a target feature spectrum of target data. The understood feature spectrum and the target feature spectrum are acquired from an output of a vector neuron layer of the machine learning model.

JP-A-2022-56611 is an example of the related art.

### SUMMARY

In the technique in the related art, data of a training set used for training of the machine learning model is the same as data that is a source of the understood feature spectrum for calculating the spectral similarity. Therefore, in the technique in the related art, in order to train the machine learning model, it may be necessary to prepare data that is the source of the understood feature spectrum, that is, a training set according to an individual purpose for using the machine learning model.

According to a first aspect of the present disclosure, an evaluation method for evaluating target data is provided. The evaluation method includes: (a) inputting a plurality of training sets to a vector neural network machine learning model having a plurality of vector neuron layers to train the machine learning model, the training sets including general-purpose training data having a type different from the target data and a label corresponding to the general-purpose training data; (b) after the step (a), inputting reference data having the same type as the target data to the trained machine learning model to acquire a reference feature spectrum as a feature spectrum from an output of a specific layer of the trained machine learning model, the reference data indicating a reference evaluation predetermined by the evaluation; (c) after the step (a), inputting the target data to be evaluated to the trained machine learning model to acquire a target feature spectrum as the feature spectrum from an output of the specific layer; (d) calculating a spectral similarity that is a similarity between the reference feature spectrum and the target feature spectrum; and (e) evaluating the target data using the spectral similarity.

According to a second aspect of the present disclosure, an evaluation apparatus for evaluating target data is provided. The evaluation apparatus includes: a training execution unit configured to input a plurality of training sets to a vector neural network machine learning model having a plurality of vector neuron layers to train the machine learning model, the training sets including general-purpose training data having a type different from the target data and a label corresponding to the general-purpose training data; a first acquisition unit configured to input reference data having the same type as the target data to the trained machine learning model to acquire a reference feature spectrum as a feature spectrum from an output of a specific layer of the trained machine learning model, the reference data indicating a reference evaluation predetermined by the evaluation; a second acquisition unit configured to input the target data to be evaluated to the trained machine learning model to acquire a target feature spectrum as the feature spectrum from an output of the specific layer; a calculation unit configured to calculate a spectral similarity that is a similarity between the reference feature spectrum and the target feature spectrum; and an evaluation unit configured to evaluate the target data using the spectral similarity.

According to a third aspect of the present disclosure, a non-transitory computer-readable storage medium storing a program causing a computer to execute an evaluation of target data is provided. The program includes: (a) a function of inputting a plurality of training sets to a vector neural network machine learning model having a plurality of vector neuron layers to train the machine learning model, the training sets including general-purpose training data having a type different from the target data and a label corresponding to the general-purpose training data; (b) a function of, after executing the function (a), inputting reference data having the same type as the target data to the trained machine learning model to acquire a reference feature spectrum as a feature spectrum from an output of a specific layer of the trained machine learning model, the reference data indicating a reference evaluation predetermined by the evaluation; (c) a function of, after executing the function (a), inputting the target data to be evaluated to the trained machine learning model to acquire a target feature spectrum as the feature spectrum from an output of the specific layer; (d) a function of calculating a spectral similarity that is a similarity between the reference feature spectrum and the target feature spectrum; and (e) a function of evaluating the target data using the spectral similarity.

### BRIEF DESCRIPTION OF THE DRAWINGS

FIG. 1 is a diagram showing an evaluation system in an embodiment.

FIG. 2 is a diagram showing a configuration of a machine learning model.

FIG. 3 is a flowchart showing a training step of the machine learning model.

FIG. 4 is a diagram showing a training set group.

FIG. 5 is a diagram showing reference data.

FIG. 6 is a diagram showing a feature spectrum.

FIG. 7 is a diagram showing a configuration of a reference feature spectrum group.

FIG. 8 is a flowchart of an evaluation step executed by an evaluation apparatus.

FIG. 9 is a flowchart showing details of step S130.

FIG. 10 is a diagram showing a first calculation method of a spectral similarity.

FIG. 11 is a conceptual diagram of a calculation formula (c1).

FIG. 12 is a diagram showing a second calculation method of the spectral similarity.

FIG. 13 is a diagram showing a third calculation method.

FIG. 14 is a diagram showing an evaluation result of the evaluation apparatus in the embodiment.

### DESCRIPTION OF EMBODIMENTS

### A. Embodiment

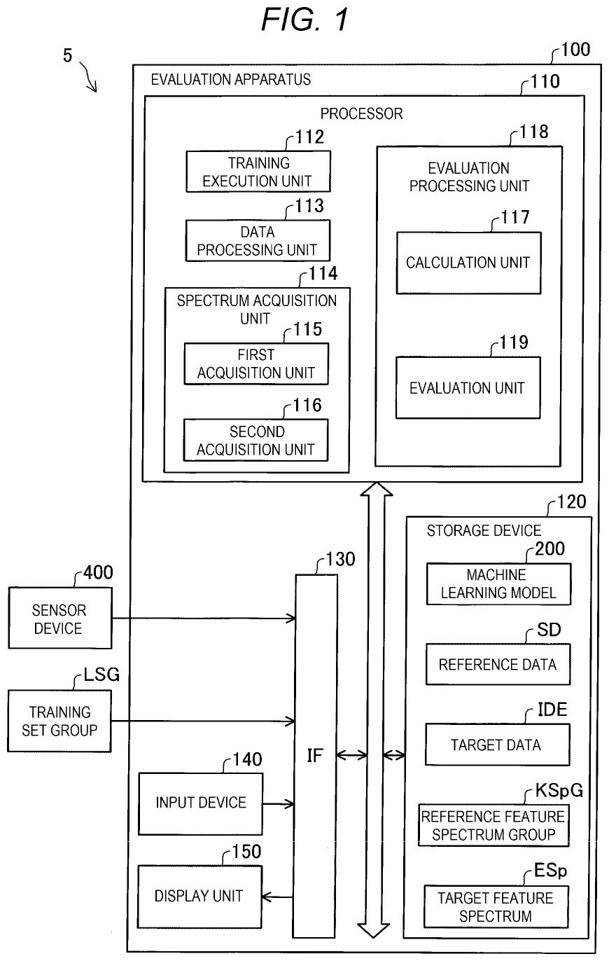

FIG. 1 is a diagram showing an evaluation system 5 in an embodiment. The evaluation system 5 is a device that evaluates various types of target data IDE, and, for example, evaluates whether a product such as a device or a component is normal, or evaluates a degree of fatigue at a target site of a person. In the embodiment, the target data IDE is a motion image obtained by imaging a robot in operation. The evaluation system 5 evaluates whether an operation of the target robot is normal by evaluating the motion image.

The evaluation system 5 includes an evaluation apparatus 100, a sensor device 400, and a training set group LSG. The sensor device 400 is a device for acquiring the target data IDE to be evaluated and original evaluation data that is a source of the target data IDE. The sensor device 400 is, for example, an imaging device or an ultrasonic device that transmits ultrasonic waves and receives reflected waves. In the embodiment, the sensor device 400 is a camera capable of imaging a motion image or a still image. The sensor device 400 can perform data communication with the evaluation apparatus 100 in a wired or wireless manner. The training set group LSG is used for training of a machine learning model 200 to be described later. For example, the training set group LSG may be stored in an external storage device different from the evaluation apparatus 100, or may be stored in a storage device 120 of the evaluation apparatus 100. The external storage device can perform data communication with the evaluation apparatus 100 in a wired or wireless manner. Details of the training set group LSG will be described later.

The evaluation apparatus 100 includes a processor 110, the storage device 120, an interface circuit 130, and an input device 140 and a display unit 150 coupled to the interface circuit 130. The evaluation appartaus 100 is, for example, a personal computer. The evaluation apparatus 100 evaluates the target data IDE using the trained machine learning model 200 stored in the storage device 120.

The processor 110 includes a training execution unit 112, a data processing unit 113, a spectrum acquisition unit 114, and an evaluation processing unit 118 by executing various programs stored in the storage device 120.

The training execution unit 112 inputs a plurality of training sets LS constituting the training set group LSG to the machine learning model 200, and executes training processing of the machine learning model 200. Details of the machine learning model 200 will be described later.

The data processing unit 113 executes data processing such as image processing on data imaged and acquired by the sensor device 400 or the like. The data processing unit 113 can execute, for example, edge extraction processing, binarization processing, and processing of extracting an object on each frame image of a motion image acquired by the sensor device 400.

The spectrum acquisition unit 114 acquires a feature spectrum Sp from an output of a specific layer of the trained machine learning model 200 by inputting input data ID to the trained machine learning model 200. The spectrum acquisition unit 114 includes a first acquisition unit 115 and a second acquisition unit 116. Details of the feature spectrum Sp will be described later.

The first acquisition unit 115 inputs reference data IDS, which is an example of the input data ID, to the trained machine learning model 200, and acquires a reference feature spectrum KSp as the feature spectrum Sp from an output of a specific layer of the trained machine learning model 200. The first acquisition unit 115 stores the acquired reference feature spectrum KSp in the storage device 120. In the embodiment, a plurality of reference feature spectra KSp are stored in the storage device 120 as a reference feature spectrum group KSpG. The reference data IDS is of the same type as the target data IDE that is another example of the input data ID. That is, the reference data IDS and the target data IDE have the same type of target as a data generation source. In the embodiment, since the target data IDE is a motion image obtained by imaging an operation of the robot, the reference data IDS is also a motion image obtained by imaging an operation of the same type of robot. That is, in the embodiment, the reference data IDS and the target data IDE are motion images constituted by a plurality of frame images arranged in time series. The reference data IDS as a generation source of the reference feature spectrum KSp is data indicating a predetermined reference evaluation. The predetermined reference evaluation may be an index that is a reference for evaluating the target data IDE, and is represented by a label LB indicating “normal” that is an example of a reference class in the embodiment. That is, the reference evaluation in the embodiment indicates an evaluation in which the operation of the robot is normal, and is an evaluation classified into the reference class.

The second acquisition unit 116 inputs the target data IDE to be evaluated to the trained machine learning model 200, and acquires a target feature spectrum ESp as the feature spectrum Sp from an output of a specific layer. The second acquisition unit 116 stores the acquired target feature spectrum ESp in the storage device 120.

The evaluation processing unit 118 evaluates the target data IDE. The evaluation processing unit 118 displays an evaluation result on the display unit 150. The evaluation processing unit 118 includes a calculation unit 117 and an evaluation unit 119.

The calculation unit 117 calculates a spectral similarity RSp that is a similarity between the reference feature spectrum KSp and the target feature spectrum ESp. A calculation method of the spectral similarity RSp will be described later.

The evaluation unit 119 evaluates the target data IDE using the calculated spectral similarity RSp. For example, the evaluation unit 119 evaluates the target data IDE by a classification related to two or more classes. In the embodiment, when the spectral similarity RSp is equal to or larger than a predetermined threshold value, the evaluation unit 119 classifies the target data IDE into “normal” that is the reference class. On the other hand, when the spectral similarity RSp is less than the threshold value, the evaluation unit 119 classifies the target data IDE into a class different from the reference class. The different class is, for example, a class labelled “abnormal”.

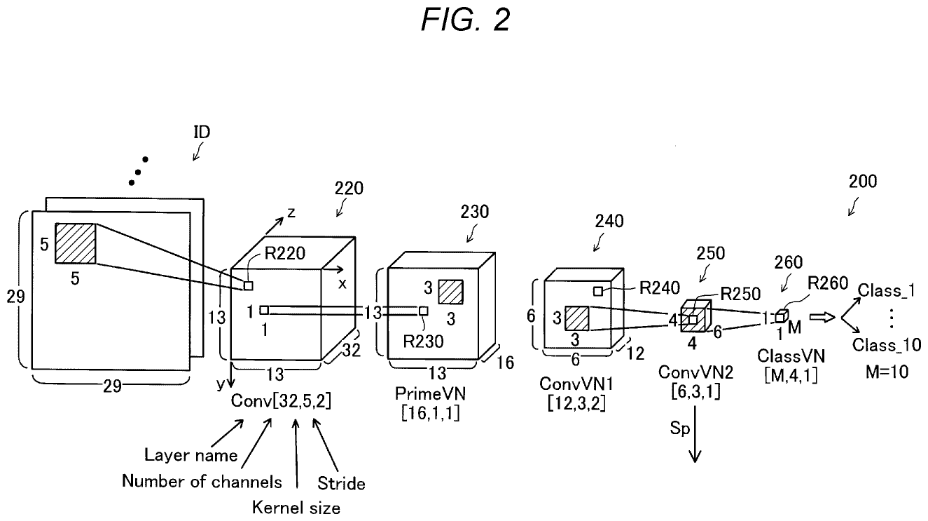

FIG. 2 is a diagram showing a configuration of the machine learning model 200. The machine learning model 200 includes, in order from an input data ID side, a convolutional layer 220, a primary vector neuron layer 230 as one of intermediate layers, a first convolutional vector neuron layer 240 as one of the intermediate layers, a second convolutional vector neuron layer 250 as one of the intermediate layers, and a classification vector neuron layer 260 as an output layer. Among the layers 220 to 260, the convolutional layer 220 is the lowest layer, and the classification vector neuron layer 260 is the highest layer. As described above, the machine learning model 200 is a vector neural network type machine learning model having a plurality of vector neuron layers 230, 240, 250, and 260. In the following description, the layers 220, 230, 240, 250, and 260 are also referred to as “Conv layer 220”, “PrimeVN layer 230”, “ConvVN1 layer 240”, “ConvVN2 layer 250”, and “ClassVN layer 260”, respectively.

In the example in FIG. 2, two convolutional vector neuron layers 240 and 250 are used, but the number of convolutional vector neuron layers may be any number, and the convolutional vector neuron layer may be omitted. It is preferable to use one or more convolutional vector neuron layers.

A configuration of each of the layers 220 to 260 can be described as follows.
Conv layer 220: Conv [32, 5, 2]
PrimeVN layer 230: PrimeVN[16, 1, 1]
ConvVN1 layer 240: ConvVN1 [12, 3, 2]
ConvVN2 layer 250: ConvVN2 [6, 3, 1]
ClassVN layer 260: ClassVN [M, 4, 1]
Vector dimension VD: VD=16

In the description of each layer, a character string before parentheses is a layer name, and numbers in the parentheses are the number of channels, a kernel surface size, and a stride in this order. For example, for the Conv layer 220, the layer name is “Conv”, the number of channels is 32, the kernel surface size is 5×5, and the stride is 2. In FIG. 2, this description is shown below each layer. A hatched rectangle drawn in each layer represents a kernel surface size used to calculate an output vector of an adjacent upper layer. In the embodiment, the input data ID is, for example, a set of frame images in a unit period tm constituting the motion image, and the kernel surface size is also two-dimensional. Values of parameters used in the description of each layer are examples, and can be freely changed. When the input data ID includes 30 frame images of 29×29 pixels, the number of channels of the input data ID is 29×29×30. Regardless of the number of channels of the input data ID, convolution processing by the Conv layer 220 produces an output having a constant size.

The Conv layer 220 is a layer constituted by scalar neurons. The other layers 230 to 260 are layers constituted by vector neurons. A vector neuron is a neuron that inputs and outputs a vector. In the above description, a dimension of an output vector of each vector neuron is 16, which is constant. Hereinafter, a term “node” is used as a generic term for the scalar neuron and the vector neurons.

In FIG. 2, for the Conv layer 220, a first axis x and a second axis y that define plane coordinates of a node array and a third axis z that represents a depth are shown. Sizes of the Conv layer 220 in x, y, and z directions being 13, 13, and 32 are also shown. The size in the x direction and the size in the y direction are referred to as “resolution”. The size in the z direction is the number of channels. The three axes x, y, and z are used as coordinate axes indicating positions of nodes in other layers. In FIG. 2, in the layers other than the Conv layer 220, illustration of these axes x, y, and z is omitted.

As is well known, resolution W1 after convolution is given by the following formula.

$$W 1 = Ceil \{ ( W 0 - Wk + 1 ) / S \} \qquad ( A1 )$$

Here, W0 is resolution before convolution, Wk is the kernel surface size, S is the stride, and Ceil{X} is a function for performing an operation of rounding up the part after the decimal point of X.

The resolution of each layer shown in FIG. 2 is an example when the resolution of the input data ID is 29, and actual resolution of each layer is appropriately changed according to a size of the input data ID.

The ClassVN layer 260 has M channels. M is the number of classes determined by the machine learning model 200. In the embodiment, M is 10, and two class determination values Class_1 to Class_10 are output. The number of channels M in the ClassVN layer 260 can be set to any integer equal to or larger than 2.

In FIG. 2, partial regions Rn in the layers 220, 230, 240, 250, and 260 are further drawn. The subscript “n” of the partial region Rn is a sign of each layer. For example, a partial region R220 indicates a partial region in the Conv layer 220. The “partial region Rn” is a region that is specified by a plane position (x, y) defined by a position in the first axis x and a position in the second axis y in each layer and includes a plurality of channels along the third axis z. The partial region Rn has dimensions of “width”×“height”×“depth” corresponding to the first axis x, the second axis y, and the third axis z. In the embodiment, the number of nodes in one “partial region Rn” is “1×1×the number of depths”, that is, “1×1×the number of channels”.

As shown in FIG. 2, for example, the feature spectrum Sp is acquired from an output of the ConvVN2 layer 250. In the present disclosure, a vector neuron layer used for calculating the spectral similarity RSp is also referred to as a “specific layer”. The specific layer may be an intermediate layer other than the ConvVN2 layer 250, and may be the ClassVN layer 260 as the output layer, or two or more layers in the vector neuron layers 230, 240, 250, and 260.

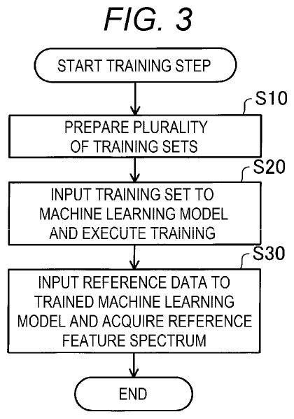

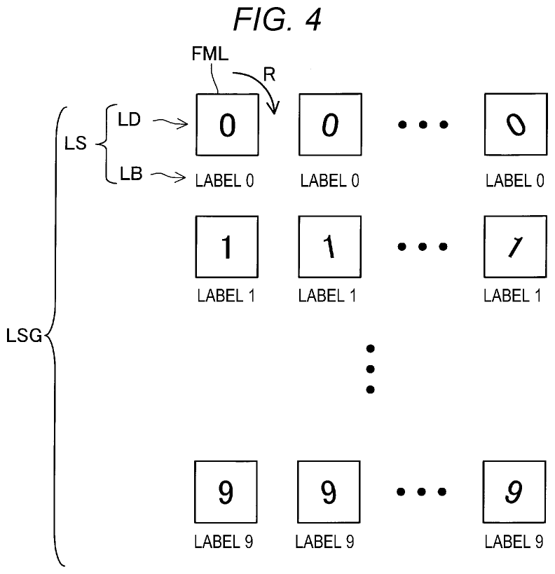

FIG. 3 is a flowchart showing a training step of the machine learning model 200. In the training step, a plurality of training sets LS are prepared in step S10. FIG. 4 is a diagram showing the training set group LSG. The training set group LSG includes a plurality of training sets LS. Each training set LS includes general-purpose training data LD and a label LB corresponding to the general-purpose training data LD.

The general-purpose training data LD is data having a type different from the target data IDE to be evaluated. The general-purpose training data LD is general data that is commonly used as training data of the machine learning model 200, and, in the embodiment, is generated based on MNIST data, which is an image representing a handwritten digit. Specifically, the general-purpose training data LD is a motion image obtained by rotating an image that is MNIST data in a predetermined rotation direction R for a predetermined time tp. The general-purpose training data LD is a set of M frame images FML at regular time intervals tv. “M” is an integer of 2 or more. That is, the general-purpose training data LD is a motion image constituted by a plurality of frame images arranged in time series. In FIG. 4, although only one frame image FML is shown for each piece of general-purpose training data LD for convenience, the general-purpose learning data LD is actually constituted by M frame images FML. In the embodiment, an image that is MNIST data is handwritten digits from “0” to “9”, and a plurality of pieces of data are prepared in which external shapes of digits differ for each digit. An image rotation speed of the general-purpose training data LD may be different or the same for each general-purpose training data LD. The rotation direction R of the general-purpose training data LD may be different or the same for each general-purpose training data LD.

The label LB indicates a digit represented by the general-purpose training data LD, and a different label is assigned to each digit. In the embodiment, labels “0” to “9” are associated with the general-purpose training data LD representing the digits “0” to “9”.

As shown in FIG. 3, in step S20, the training execution unit 112 inputs each training set LS in the training set group LSG to the machine learning model 200, and executes training of the machine learning model 200. Specifically, the training execution unit 112 trains the machine learning model 200 so as to reproduce a correspondence between the general-purpose training data LD and the label LB associated with the general-purpose training data LD. The general-purpose training data LD of the training set group LSG is data-converted into NumPy format suitable for the machine learning model 200. Other input data ID input to the machine learning model 200 is also data-converted into NumPy format similarly to the general-purpose training data LD.

Next, in step S30, the first acquisition unit 115 inputs the reference data IDS to the trained machine learning model 200, and acquires the reference feature spectrum KSp from an output of a specific layer in the machine learning model 200. The acquired reference feature spectrum KSp is stored in the storage device 120. In the embodiment, the specific layer is the ConvVN2 layer 250.

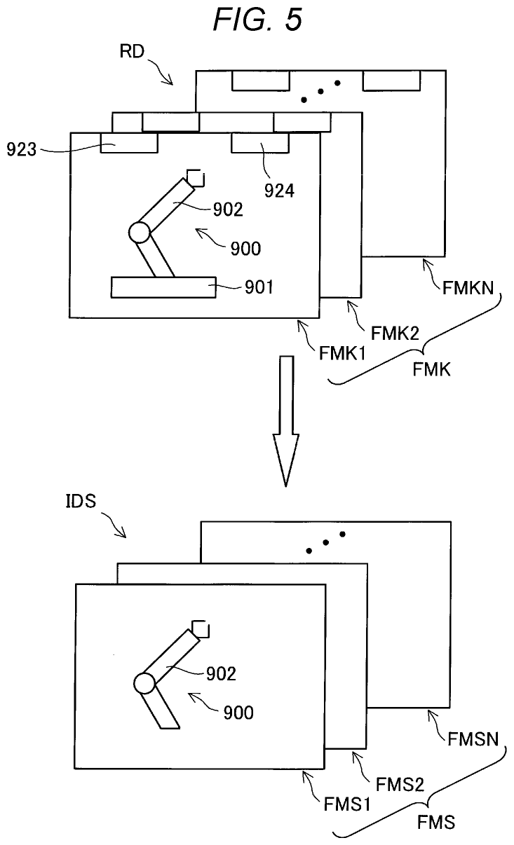

FIG. 5 is a diagram showing the reference data IDS. The reference data IDS in the embodiment is a motion image generated based on an original reference motion image RD obtained by imaging movement of a robot 900 as a reference object that operates normally. The robot 900 includes a base 901 and an arm 902 coupled to the base 901. In the robot 900 that operates normally, the arm 902 reciprocates between a start point and an end point at a constant speed. The original reference motion image RD is a set of reference frame images FMK1 to FMKN obtained by imaging a state in which the robot 900 operates normally for a predetermined reference time ts. The predetermined reference time ts may be the same as or different from the time tp of a motion image of the general-purpose training data LD, which is a motion image. The number of the reference frame images FMK1 to FMKN may be the same as or different from the number of the frame images FML of the general-purpose training data LD. In the embodiment, the original reference motion image RD includes N reference frame images FMK1 to FMKN. “N” is an integer of 2 or more. When the N reference frame images FMK1 to FMKN are used without being distinguished, the reference frame image FMK is used.

The data processing unit 113 uses the plurality of reference frame images FMK1 to FMKN constituting the original reference motion image RD to execute image processing of extracting the robot 900, which is a moving reference object, specifically the arm 902, from the reference frame image FMK, thereby generating a plurality of processed reference frame images FMS. That is, the data processing unit 113 generates a plurality, N in the embodiment, of processed reference frame images FMS arranged in time series as the reference data IDS. The data processing unit 113 calculates an average value of pixel values for each pixel of the plurality of reference frame images FMS1 to FMSN. The data processing unit 113 calculates an absolute value of a difference between each pixel of the reference frame image FMK and an average value of corresponding pixels for each of the plurality of reference frame images FMK1 to FMKN, and generates a set of absolute values of differences in the pixels as the processed reference frame image FMS. Accordingly, the stationary base 901, stationary objects 923 and 924 and background are removed from the processed reference frame image FMS, and the robot 900 as the moving reference object, specifically, the arm 902 is extracted. However, data processing of extracting the moving reference object from the reference frame image FMK is not limited to the above. For example, the data processing unit 113 may generate the processed reference frame image FMS in which the reference object is extracted by executing data processing such as pattern recognition processing or edge extraction processing on the reference frame image FMK.

A plurality of pieces of reference data IDS may be prepared. In the embodiment, a plurality of pieces of reference data IDS are prepared. The plurality of pieces of reference data IDS may be generated based on divided data obtained by dividing the motion image of the robot 900 that operates normally into a plurality of periods, or may be generated based on the motion image acquired by individually acquiring the motion image of the robot 900 that operates normally. When the plurality of pieces of reference data IDS are generated based on the divided data, a generation period of one piece of reference data IDS and a generation period of another piece of reference data IDS may or may not partially overlap each other.

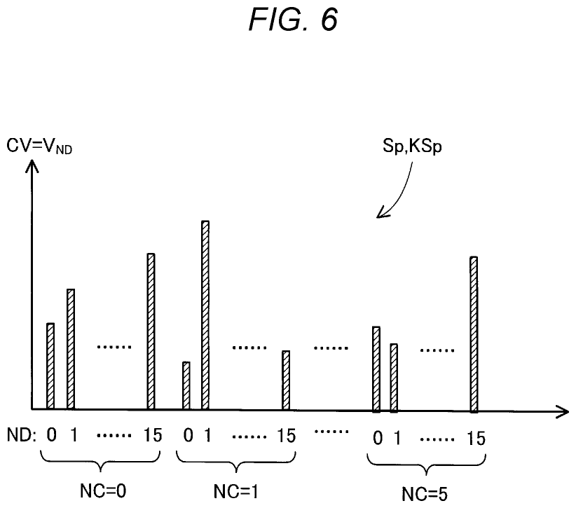

FIG. 6 is a diagram showing the feature spectrum Sp obtained by inputting any input data ID to the trained machine learning model 200. In FIG. 6, the reference feature spectrum KSp corresponding to one piece of reference data IDS is shown as a specific example.

A horizontal axis in FIG. 6 is a position of a vector element related to an output vector of a plurality of nodes in one partial region R250 of the ConvVN2 layer 250. The position of the vector element is represented by a combination of an element number ND of the output vector in each node and a channel number NC. In the embodiment, the vector dimension is 16, that is, the number of elements of the output vector output by each node is 16, so that the element number ND of the output vector is 16 from 0 to 15. The number of channels of the ConvVN2 layer 250 is 6, so that the channel number NC is 6 from 0 to 5. Therefore, the number of elements of the feature spectrum Sp is 96, which is 16×6. The feature spectrum Sp having 96 elements represents the feature spectrum Sp of the reference data IDS constituted by the N reference frame images FMS1 to FMSN. The feature spectrum Sp is obtained by arranging a plurality of element values of the output vector of each vector neuron in one partial region R250 across a plurality of channels along the third axis z.

A vertical axis in FIG. 6 indicates a feature value CV at each spectral position. In this example, the feature value CV is a value V_{ND} of each element of the output vector. The feature value CV may be subjected to statistical processing such as centering to an average value 0. As the feature value CV, a value obtained by multiplying the value V_{ND} of each element of the output vector by a normalization coefficient to be described later may be used, or the normalization coefficient may be used as it is. In the latter case, the number of feature values CV in the feature spectrum Sp is equal to the number of channels and is 6. The normalization coefficient is a value corresponding to a vector length of an output vector of a node.

The number of feature spectra Sp obtained from an output of the ConvVN2 layer 250 for one piece of input data ID is 9, which is equal to the number of plane positions (x, y) of the ConvVN2 layer 250, that is, the number of partial regions R250.

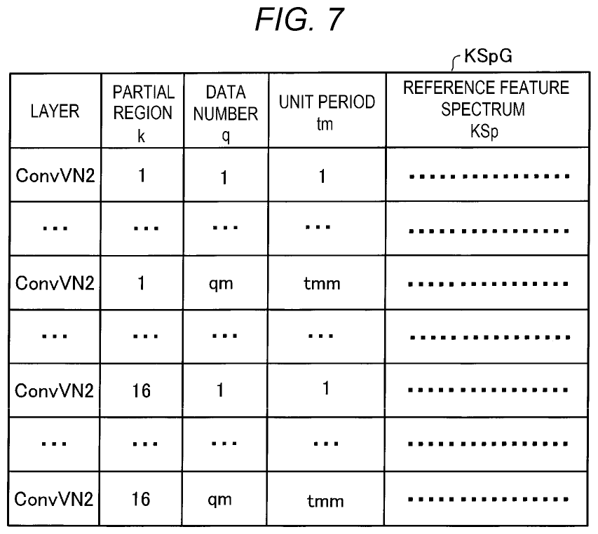

FIG. 7 is a diagram showing a configuration of the reference feature spectrum group KSpG. In this example, the reference feature spectrum group KSpG that is a set of reference feature spectra KSp as understood feature spectra acquired from the output of the ConvVN2 layer 250 is shown. As the reference feature spectrum group KSpG, a group obtained from an output of at least one vector neuron layer may be registered, and a reference feature spectrum group obtained from an output of the ConvVN1 layer 240 or the ClassVN layer 260 may be registered.

Each record in the reference feature spectrum group KSpG includes a parameter k indicating an order of the partial regions Rn in a layer, a parameter q indicating a data number, a parameter tm indicating a unit period divided at regular intervals in a motion image, and the reference feature spectrum KSp. A set of time-series frame images in the unit period tm constitutes the reference data IDS. For example, a plurality of pieces of reference data IDS are generated by dividing the motion image having the same data number q for each unit period tm. The reference feature spectrum KSp is the same as the feature spectrum Sp in FIG. 6.

The parameter k of the partial region Rn takes a value indicating which of a plurality of partial regions Rn, that is, which of plane positions (x, y) in a specific layer. In the ConvVN2 layer 250, the number of partial regions R250 is 16, and k=1 to 16. The parameter q of the data number is a number for identifying a motion image that is a source of the reference data IDS.

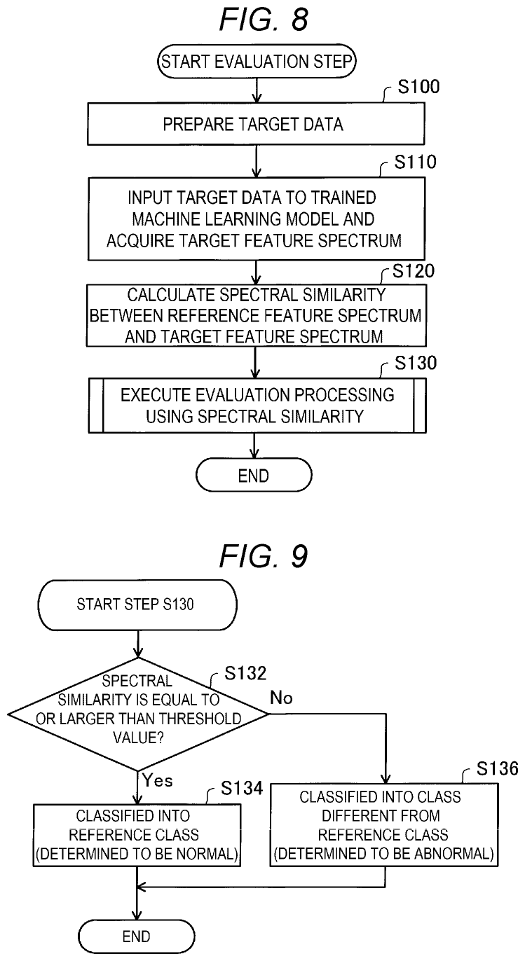

FIG. 8 is a flowchart of an evaluation step executed by the evaluation apparatus 100. First, in step S100, the target data IDE is prepared. In the embodiment, a plurality of processed target frame images in which the robot 900, specifically, the arm 902 of the robot 900 is extracted as an evaluation object are generated using a plurality of target frame images constituting an original target motion image. A plurality of evaluation frame images constitute original target motion images arranged in time series acquired by the sensor device 400. The original target motion image is data obtained by imaging movement of the robot 900 for a predetermined reference time ts. The predetermined reference time ts may be the same as or different from the reference time ts that is an imaging time of the original reference motion image RD, which is source data of the reference data IDS. The data processing unit 113 executes, by the same method as the image processing of generating the reference data IDS based on the original reference motion image RD, image processing of extracting the moving arm 902 of the robot 900 as the evaluation object from the original target motion image. The data processing unit 113 extracts data for each of a plurality of unit periods tm from the motion image after the image processing, thereby generating a plurality of pieces of target data IDE constituted by a plurality of processed target frame images. As described above, the data processing unit 113 generates, using a plurality of target frame images constituting the original target motion image acquired by imaging the movement of the robot 900, a plurality of processed target frame images in which the robot 900 is extracted. Accordingly, the data processing unit 113 generates a plurality of processed target frame images arranged in time series as the target data IDE.

Next, in step S110, the second acquisition unit 116 inputs the target data IDE to be evaluated to the trained machine learning model 200, and acquires the target feature spectrum ESp from the output of the ConvVN2 layer 250 that is a specific layer. A data configuration of the target feature spectrum ESp is the same as that of the reference feature spectrum KSp shown in FIGS. 6 and 7.

Next, in step S120, the calculation unit 117 calculates the spectral similarity RSp between the reference feature spectrum KSp and the target feature spectrum ESp. The target feature spectrum ESp has the same configuration as the feature spectrum Sp shown in FIG. 6. Details of a calculation method of the spectral similarity RSp will be described later.

Next, in step S130, the evaluation unit 119 executes evaluation processing of the target data IDE using the spectral similarity RSp.

FIG. 9 is a flowchart showing details of step S130. In step S132, the evaluation unit 119 determines whether the spectral similarity RSp is equal to or larger than a threshold value. When the spectral similarity RSp is equal to or larger than the threshold value, in step S134, the evaluation unit 119 classifies the target data IDE into the reference class. In the embodiment, as described above, the reference class has a label of “normal” indicating that the movement of the robot 900 is normal. On the other hand, when the spectral similarity RSp is less than the threshold value, in step S136, the evaluation unit 119 classifies the target data IDE into a class different from the reference class. In the embodiment, the different class has a label of “abnormal” indicating that there is an abnormality in the movement of the robot 900. In the embodiment, for the plurality of processed target frame images arranged in time series constituting the target data IDE, the evaluation processing in step S130 is sequentially executed for each set of individual target feature spectra IESp corresponding to the plurality of processed target frame images arranged in time series, that is, for each unit period tm. The evaluation unit 119 displays evaluation information indicating a result of the evaluation processing on the display unit 150. For example, when label determination of “abnormal” is made, the evaluation information including information indicating “abnormal” and a time point t at which the target frame image that is a source of the processed target frame image subjected to the label classification of “abnormal” is acquired, that is, time point information at which the abnormality occurs is displayed on the display unit 150. The evaluation information may be color information corresponding to a magnitude of the spectral similarity RSp. For example, the evaluation unit 119 outputs, to the display unit, a color that gradually becomes red as the spectral similarity RSp increases. Thus, the evaluation unit 119 can easily classify the target data IDE into classes for each unit period tm by determining whether the spectral similarity RSp is equal to or larger than the threshold value.

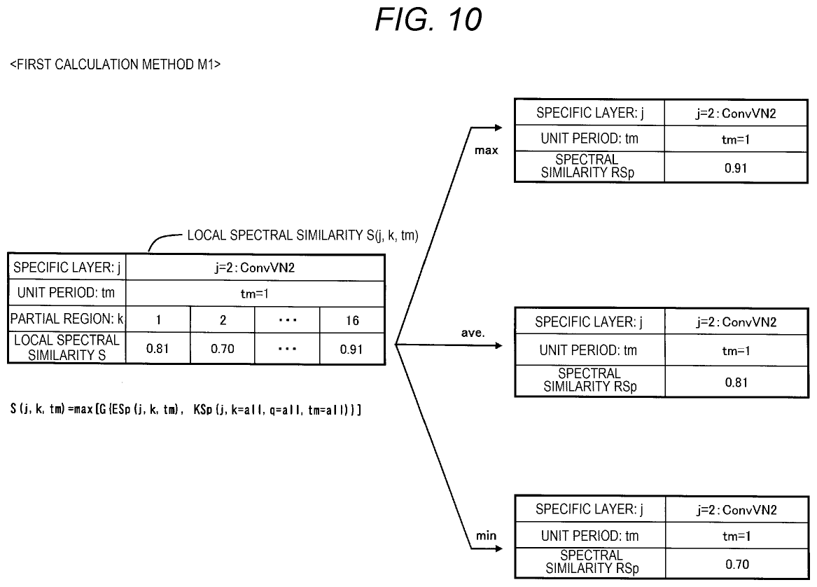

Next, an example of the calculation method of the spectral similarity RSp will be described. FIG. 10 is a diagram showing a first calculation method M1 of the spectral similarity RSp. In the first calculation method M1, first, a local spectral similarity S(j, k, tm) is calculated for each partial region Rn from the output of the ConvVN2 layer 250 as the specific layer. In the embodiment, a calculation source of the spectral similarity RSp is a motion image constituted by a plurality of frame images. Therefore, the calculation unit 117 calculates the spectral similarity RSp between the feature spectra Sp generated based on the input data ID that is a set of a predetermined number of frame images in which continuous frame image numbers NFM are arranged in time series. The predetermined number corresponds to a time interval Δt at which the evaluation processing in step S130 shown in FIG. 9 is executed. When a frame rate of the motion image is 60 fps and the time interval Δt is 0.5 seconds, the predetermined number is 30. That is, each of the target data IDE and the reference data IDS is a set of 30 frame images having continuous frame image numbers NFM. The spectral similarity RSp between the feature spectrum Sp generated by inputting each of the target data IDE and the reference data IDS as the input data ID to the machine learning model 200 is calculated. It is preferable that the number of continuous frame image numbers NFM is the same for each of the target data IDE and the reference data IDS as a calculation source of the spectral similarity RSp. For each of the target data IDE and the reference data IDS that are calculation sources of the spectral similarity RSp, the frame image number NFM of the frame image constituting the target data IDE and the frame image number NFM of the frame image constituting the reference data IDS may be the same or different. An example of the calculation method of the spectral similarity RSp will be described below.

In the first calculation method M1, the local spectral similarity S(j, k, tm) is calculated using the following formula.

$$S ( j , k , tm ) = max [ G \{ ESp ( j , k , tm ) , KSp ( j , k = all , q = all , tm = all ) \} ] \qquad ( c1 )$$

j is a parameter indicating a specific layer.
k is a parameter indicating a partial region Rn.
q is a parameter indicating a data number.
tm is a parameter indicating a unit period divided at regular intervals in a motion image. A time in each unit period is the same. FIG. 10 is a diagram when the unit period tm is “1”.
G{a, b} is a function for obtaining a spectral similarity between a and b.
ESp (j, k, tm) is a target feature spectrum ESp corresponding to a set of a plurality of frame images acquired in a unit period indicated by the parameter tm of the target data IDE that is a motion image among the target feature spectra ESp obtained from an output of a specific partial region Rn of a specific layer j.
max [X] is a logical operation that takes a maximum value among values of X.
KSp (j, k, q=all, tm=all) is a reference feature spectrum KSp corresponding to a set of a plurality of frame images acquired for every unit period among the reference feature spectra KSp having all data numbers q obtained from an output of a specific partial region Rn of a specific layer j.

Note that, as the function G{a, b} for obtaining the local spectral similarity, for example, an expression for obtaining a cosine similarity or an expression for obtaining a similarity according to a distance can be used.

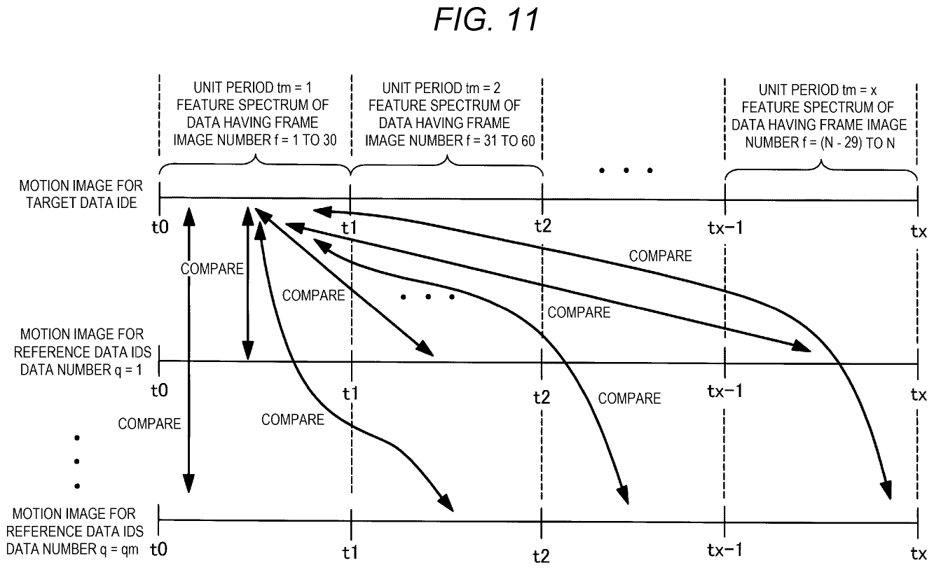

FIG. 11 is a conceptual diagram of the calculation formula (c1). In the calculation method of the formula (c1), as a comparison target of the spectral similarity RSp for the feature spectrum Sp corresponding to the unit period tm of the target data IDE, for example, the unit period tm1, the feature spectrum Sp corresponding to each of all unit periods tm0 to tm (N−1) of the reference data IDS is used. The reference data IDS having all data numbers q is used as a comparison target of the spectral similarity RSp for the feature spectrum Sp corresponding to the unit period tm of the target data IDE, for example, the unit period tm1.

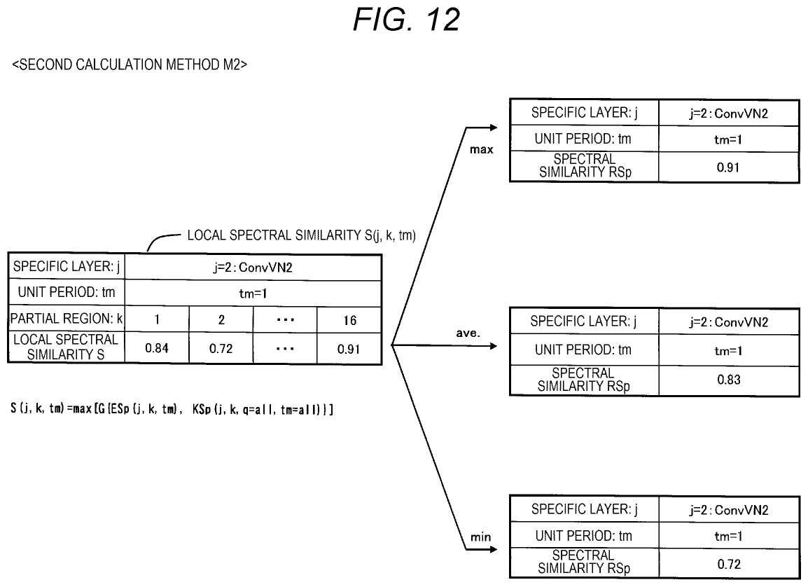

FIG. 12 is a diagram showing a second calculation method M2 of the spectral similarity RSp. In the second calculation method M2, the local spectral similarity S (j, k, tm) is calculated using the following formula.

$$S ( j , k , tm ) = max [ G \{ ESp ( j , k , tm ) , KSp ( j , k , q = all , tm = all ) \} ] \qquad ( c 2 )$$

In the first calculation method M1 described above, the reference feature spectrum KSp (j, k=all, q=all, tm=all) in all partial regions k of the specific layer j is used. On the other hand, in the second calculation method M2, only the reference feature spectrum KSp for the same partial region k as the partial region k of the individual target feature spectrum IESp is used. Other methods in the second calculation method M2 are the same as those in the first calculation method M1.

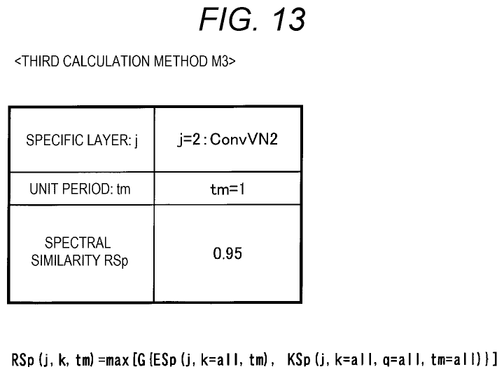

FIG. 13 is a diagram showing a third calculation method M3. In the third calculation method M3, the spectral similarity RSp is calculated using the following formula.

$$RSp ( j , k , tm ) = max [ G \{ ESp ( j , k = all , tm ) , KSp ( j , k = all , q = all , tm = all ) \} ] \qquad ( c2 )$$

That is, a plurality of individual spectral similarities S are calculated by comparing each of the plurality of target feature spectra ESp obtained from outputs of all the partial regions Rn generated from the specific layer j in the target data IDE having a certain unit period tm with each of the reference feature spectra KSp obtained from outputs of all the partial regions Rn for each of all the reference data IDS. A maximum value among the calculated individual spectral similarities S is calculated as the spectral similarity RSp.

In relation to the first calculation method M1 to the third calculation method M3, the spectral similarity RSp may be calculated by comparing the target data IDE and the reference data IDS having the same unit period tm respectively and calculating the individual spectral similarity S.

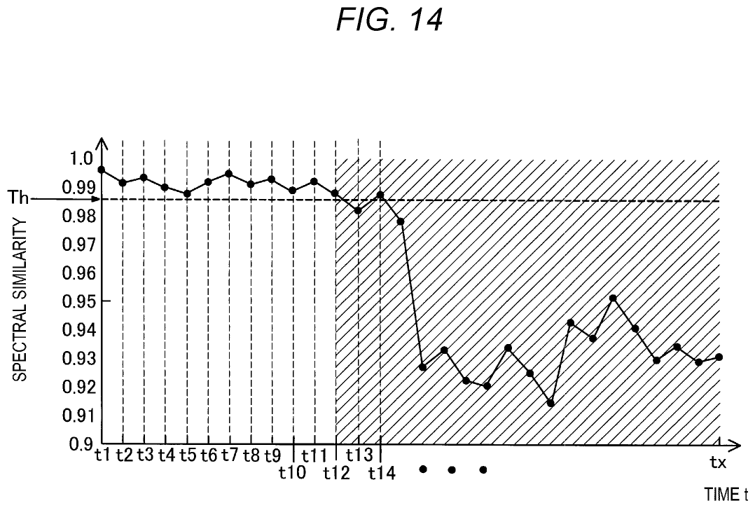

FIG. 14 is a diagram showing an evaluation result of the evaluation apparatus 100 in the embodiment. The machine learning model 200 is trained by preparing 10,000 sets of training sets LS in which images of MNIST data are used as the general-purpose training data LD. The reference data IDS is a motion image of the robot 900 that operates normally. On the other hand, the target data IDE is a motion image of the robot 900 that operates normally in a certain period until a time point t12 and operates abnormally in remaining other period after the time point t12. A period indicated by single hatching after the time point t12 shown in FIG. 14 is a period in which the robot 900 operates abnormally. The spectral similarity RSp is calculated at each end point of a unit period. In the embodiment, for example, the spectral similarity RSp in a unit period from a time point t0 to a time point t1 is calculated immediately after the time point t1. A threshold value th in step S132 shown in FIG. 9 is set based on a normal spectral similarity, which is the spectral similarity RSp for each unit period in a certain period in which the robot 900 indicated by the target data IDE operates normally. Specifically, the threshold value th is set to a value obtained by subtracting 3σ of a distribution of respective normal spectral similarities from an average value of the respective normal spectral similarities.

With respect to a result of the evaluation of the target data IDE executed by the evaluation apparatus 100, in the period until the time point t12 when the robot 900 operates normally, the spectral similarity RSp is equal to or larger than the threshold value th and the target data IDE is classified as the reference class indicating normal. In a period after the time point t12 at which the robot 900 operates abnormally, a proportion of the spectral similarity RSp being less than the threshold value th exceeds 90%. Therefore, in the period after the time point t12, a probability that the target data IDE is correctly classified as a class indicating abnormality is high. Accordingly, accuracy of the evaluation result of the target data IDE using the machine learning model 200 that is trained using the general-purpose training data LD is high.

According to the above embodiment, by training the machine learning model 200 using the general-purpose training data LD having a type different from the target data IDE to be evaluated, it is not necessary to prepare a training set for the machine learning model 200 for each purpose even when types of target data IDE are different and purposes of using the machine learning model 200 are different. According to the embodiment, an evaluation of the target data IDE is executed by using the feature spectrum Sp acquired from an output of a specific layer instead of an evaluation using a determination value according to each class output from an output layer. Accordingly, even when the machine learning model 200 is trained using the general-purpose training data LD, it is possible to accurately evaluate the target data IDE.

According to the above embodiment, the reference feature spectrum KSp is acquired from the reference data IDS obtained in which the arm 902 of the robot 900, which is the reference object, is extracted from the original reference motion image RD. Accordingly, it is possible to acquire the feature spectrum Sp that further represents a feature for the robot 900, which is a comparison source for calculating the spectral similarity RSp, and in particular, an normal operation of the robot 900. Therefore, evaluation accuracy of the target data IDE can be further improved. According to the above embodiment, since the target feature spectrum ESp is acquired from the target data IDE in which the robot 900, which is the evaluation object, is extracted from an original object motion image, it is possible to acquire the feature spectrum Sp that further represents a feature for the robot 900, in particular, the movement of the robot 900. Accordingly, the evaluation accuracy of the target data IDE can be further improved.

### B. Other Embodiments

### B-1. Other Embodiment 1

Although the general-purpose training data LD, the reference data IDS, and the target data IDE are motion images in the above embodiment, each piece of data may be a still image or two-dimensional data in which a physical quantity is defined on a first axis and a time is defined on a second axis. The two-dimensional data is, for example, data indicating a change in voltage over time. In the above embodiment, the trained machine learning model 200 is used for the purpose of determining whether an operation of the robot 900 indicated by the target data IDE is normal, but the trained machine learning model 200 may be used for other purposes. A specific example will be described below.

The evaluation apparatus 100 in the present disclosure is applicable to an evaluation using an exercise apparatus. The exercise apparatus can perform data communication with the evaluation apparatus 100 in a wired or wireless manner. The exercise apparatus is, for example, a treadmill, an Aerobike (registered trademark), or a muscle force training machine. The treadmill is a device in which a belt is moved by a motor based on a setting of a user, and the user can exercise by walking or running on the belt. The treadmill includes a treadmill main body having a motor and a belt, an ultrasonic device that is an example of the sensor device 400 capable of measuring a state of a muscle of the user, and a controller for controlling the treadmill main body and the ultrasonic device. The muscle force training machine can electrically change a load applied to a target site as a training target of the user in weight training.

The machine learning model 200 is trained using a plurality of training sets in which each set includes the general-purpose training data LD, which is MNIST data that is a still image, and the label LB associated with the general-purpose training data LD.

The reference data IDS is, for example, data indicating a state of a muscle as a target site of a subject other than the user, and is an ultrasonic image of the muscle acquired by the ultrasonic device. A reference evaluation associated with the reference data IDS indicates that a state of the muscle at the target site of the subject is good, that is, a state in which the muscle at the target site does not feel fatigued.

The target data IDE is an ultrasonic image of a muscle at a target site when the user exercises using the exercise apparatus. The target data IDE is acquired and evaluated at regular time intervals. The evaluation apparatus 100 calculates the spectral similarity RSp between the reference feature spectrum KSp of the reference data IDS and the target feature spectrum ESp of the target data IDE. When the calculated spectral similarity RSp is equal to or larger than a threshold value, the evaluation unit 119 performs a classification indicating that the target site of the user is not fatigued. On the other hand, when the calculated spectral similarity RSp is less than the threshold value, the evaluation unit 119 performs a classification indicating that the target site of the user is fatigued, and executes predetermined post-processing. In the post-processing, the display unit 150 displays warning information that prompts the user to reduce a load of the exercise apparatus or stop the exercise by the exercise apparatus, or transmits a load reduction command that is a command to reduce the load or a command to stop the operation to the exercise apparatus. When the load is reduced in the treadmill, the controller of the treadmill reduces a rotation speed of the motor.

The reference data IDS may be prepared for each of a plurality of levels of reference evaluations. For example, a degree of fatigue at the target site of the subject is classified into a plurality of levels, and the target data IDE is acquired for each degree of fatigue that is the reference evaluation. For example, regarding the reference evaluation, the degree of fatigue may be represented in three levels of “low”, “medium”, and “high”, and the reference feature spectrum KSp may be acquired from the reference data IDS corresponding to each reference evaluation. The calculation unit 117 calculates, for each reference evaluation, that is, for each degree of fatigue, the spectral similarity RSp between the reference feature spectrum KSp corresponding to each degree of fatigue and the target feature spectrum ESp of the target data IDE. The evaluation unit 119 specifies the reference feature spectrum KSp that is a calculation source of the spectral similarity RSp indicating the largest value among a plurality of spectral similarities RSp calculated for each reference evaluation. The evaluation unit 119 evaluates the reference evaluation associated with the specified reference feature spectrum KSp, that is, the degree of fatigue, as the degree of fatigue at the target site of the user. The evaluation unit 119 transmits a load setting command corresponding to the evaluated degree of fatigue to the exercise apparatus.

When the target data IDE and the reference data IDS are not motion images but still images acquired at each time point or data indicating physical quantities such as a voltage and a current detected by the sensor device 400 for a predetermined time, the parameter tm is omitted in the first to third calculation methods.

### C. Other Aspects

The present disclosure is not limited to the above embodiments, and can be implemented in various aspects without departing from the spirit of the present disclosure. For example, the present disclosure can be implemented by the following aspects. In order to solve a part of or all of problems of the present disclosure, or to achieve a part of or all of effects of the present disclosure, technical features of the above embodiments corresponding to technical features in each of the following aspects can be replaced or combined as appropriate. The technical characteristics can be deleted as appropriate unless described as essential in the present specification.

(1) According to a first aspect of the present disclosure, an evaluation method for evaluating target data is provided. The evaluation method includes: (a) inputting a plurality of training sets to a vector neural network machine learning model having a plurality of vector neuron layers to train the machine learning model, the training sets including general-purpose training data having a type different from the target data and a label corresponding to the general-purpose training data; (b) after the step (a), inputting reference data having the same type as the target data to the trained machine learning model to acquire a reference feature spectrum as a feature spectrum from an output of a specific layer of the trained machine learning model, the reference data indicating a reference evaluation predetermined by the evaluation; (c) after the step (a), inputting the target data to be evaluated to the trained machine learning model to acquire a target feature spectrum as the feature spectrum from an output of the specific layer; (d) calculating a spectral similarity that is a similarity between the reference feature spectrum and the target feature spectrum; and (e) evaluating the target data using the spectral similarity. According to the aspect, by training the machine learning model using the general-purpose training data having a type different from the target data to be evaluated, it is not necessary to prepare a training set for the machine learning model for each purpose even when types of target data are different and purposes of using the machine learning model are different. According to the aspect, an evaluation of the target data is executed by using the feature spectrum acquired from an output of a specific layer instead of an evaluation using a determination value according to each class output from an output layer. Accordingly, even when the machine learning model is trained using the general-purpose training data, it is possible to accurately evaluate the target data.

(2) In the above aspect, in (e), the target data may be evaluated according to a classification related to two or more classes. The reference evaluation may be an evaluation classified into a reference class. In (e), the target data may be classified into the reference class when the spectral similarity is equal to or larger than a predetermined threshold value, and the target data may be classified into a class different from the reference class when the spectral similarity is less than the threshold value. According to the aspect, it is possible to easily classify the target data by determining whether the spectral similarity is equal to or larger than the threshold value.

(3) In the above aspect, the plurality of vector neuron layers may include, in order from a side of the target data that is input data, a convolutional vector neuron layer that is an intermediate layer and a classification vector neuron layer that is an output layer. The specific layer may be the intermediate layer. According to the aspect, it is possible to evaluate the target data using the feature spectrum acquired from an output of the intermediate layer.

(4) In the above aspect, each of the general-purpose training data, the reference data, and the target data may be a motion image constituted by a plurality of frame images arranged in time series. The evaluation method may further include: (f) generating, using a plurality of reference frame images constituting an original reference motion image acquired by imaging movement of a reference object, a plurality of processed reference frame images in which the reference object is extracted, thereby generating the plurality of processed reference frame images arranged in time series as the reference data. According to the aspect, since the reference feature spectrum is acquired from the reference data in which the reference object is extracted from the original reference motion image, it is possible to acquire the feature spectrum further representing the feature of the reference object. Accordingly, the evaluation accuracy of the target data can be further improved.

(5) In the above aspect, each of the general-purpose training data, the reference data, and the target data may be a motion image constituted by a plurality of frame images arranged in time series. The evaluation method may further include: (g) generating, using a plurality of target frame images constituting an original target motion image acquired by imaging movement of an evaluation object, a plurality of processed target frame images in which the evaluation object is extracted, thereby generating the plurality of processed target frame images arranged in time series as the target data.

(6) According to a second aspect of the present disclosure, an evaluation apparatus for evaluating target data is provided. The evaluation apparatus includes: a training execution unit configured to input a plurality of training sets to a vector neural network machine learning model having a plurality of vector neuron layers to train the machine learning model, the training sets including general-purpose training data having a type different from the target data and a label corresponding to the general-purpose training data; a first acquisition unit configured to input reference data having the same type as the target data to the trained machine learning model to acquire a reference feature spectrum as a feature spectrum from an output of a specific layer of the trained machine learning model, the reference data indicating a reference evaluation predetermined by the evaluation; a second acquisition unit configured to input the target data to be evaluated to the trained machine learning model to acquire a target feature spectrum as the feature spectrum from an output of the specific layer; a calculation unit configured to calculate a spectral similarity that is a similarity between the reference feature spectrum and the target feature spectrum; and an evaluation unit configured to evaluate the target data using the spectral similarity. According to the aspect, by training the machine learning model using the general-purpose training data having a type different from the target data to be evaluated, it is not necessary to prepare a training set for the machine learning model for each purpose even when types of target data are different and purposes of using the machine learning model are different. According to the aspect, an evaluation of the target data is executed by using the feature spectrum acquired from an output of a specific layer instead of an evaluation using a determination value according to each class output from an output layer. Accordingly, even when the machine learning model is trained using the general-purpose training data, it is possible to accurately evaluate the target data.

(7) According to a third aspect of the present disclosure, a non-transitory computer-readable storage medium storing a program is provided, the program causing a computer to execute an evaluation of target data. The program includes: (a) a function of inputting a plurality of training sets to a vector neural network machine learning model having a plurality of vector neuron layers to train the machine learning model, the training sets including general-purpose training data having a type different from the target data and a label corresponding to the general-purpose training data; (b) a function of, after executing the function (a), inputting reference data having the same type as the target data to the trained machine learning model to acquire a reference feature spectrum as a feature spectrum from an output of a specific layer of the trained machine learning model, the reference data indicating a reference evaluation predetermined by the evaluation; (c) a function of, after executing the function (a), inputting the target data to be evaluated to the trained machine learning model to acquire a target feature spectrum as the feature spectrum from an output of the specific layer; (d) a function of calculating a spectral similarity that is a similarity between the reference feature spectrum and the target feature spectrum; and (e) a function of evaluating the target data using the spectral similarity. According to the aspect, by training the machine learning model using the general-purpose training data having a type different from the target data to be evaluated, it is not necessary to prepare a training set for the machine learning model for each purpose even when types of target data are different and purposes of using the machine learning model are different. According to the aspect, an evaluation of the target data is executed by using the feature spectrum acquired from an output of a specific layer instead of an evaluation using a determination value according to each class output from an output layer. Accordingly, even when the machine learning model is trained using the general-purpose training data, it is possible to accurately evaluate the target data.

The present disclosure can be implemented in various forms other than the above aspects. For example, the present disclosure can be implemented in the form of a non-transitory storage medium on which a computer program is recorded.

What is claimed is:

1. An evaluation method for evaluating target data, the evaluation method comprising:
(a) inputting a plurality of training sets to a vector neural network machine learning model having a plurality of vector neuron layers to train the machine learning model, the training sets including general-purpose training data having a type different from the target data and a label corresponding to the general-purpose training data;
(b) after the step (a), inputting reference data having the same type as the target data to the trained machine learning model to acquire a reference feature spectrum as a feature spectrum from an output of a specific layer of the trained machine learning model, the reference data indicating a reference evaluation predetermined by the evaluation;
(c) after the step (a), inputting the target data to be evaluated to the trained machine learning model to acquire a target feature spectrum as the feature spectrum from an output of the specific layer;
(d) calculating a spectral similarity that is a similarity between the reference feature spectrum and the target feature spectrum; and
(e) evaluating the target data using the spectral similarity.

2. The evaluation method according to claim 1, wherein
in (e), the target data is evaluated according to a classification related to two or more classes,
the reference evaluation is an evaluation classified into a reference class, and
in (e),
the target data is classified into the reference class when the spectral similarity is equal to or larger than a predetermined threshold value, and
the target data is classified into a class different from the reference class when the spectral similarity is less than the threshold value.

3. The evaluation method according to claim 1, wherein
the plurality of vector neuron layers include, in order from a side of the target data that is input data, a convolutional vector neuron layer that is an intermediate layer and a classification vector neuron layer that is an output layer, and
the specific layer is the intermediate layer.

4. The evaluation method according to claim 1, wherein
each of the general-purpose training data, the reference data, and the target data is a motion image constituted by a plurality of frame images arranged in time series, and
the evaluation method further comprises:
(f) generating, using a plurality of reference frame images constituting an original reference motion image acquired by imaging movement of a reference object, a plurality of processed reference frame images in which the reference object is extracted, thereby generating the plurality of processed reference frame images arranged in time series as the reference data.

5. The evaluation method according to claim 1, wherein
each of the general-purpose training data, the reference data, and the target data is a motion image constituted by a plurality of frame images arranged in time series, and
the evaluation method further comprises:
(g) generating, using a plurality of target frame images constituting an original target motion image acquired by imaging movement of an evaluation object, a plurality of processed target frame images in which the evaluation object is extracted, thereby generating the plurality of processed target frame images arranged in time series as the target data.

6. An evaluation apparatus for evaluating target data, the evaluation apparatus comprising:
a training execution unit configured to input a plurality of training sets to a vector neural network machine learning model having a plurality of vector neuron layers to train the machine learning model, the training sets including general-purpose training data having a type different from the target data and a label corresponding to the general-purpose training data;
a first acquisition unit configured to input reference data having the same type as the target data to the trained machine learning model to acquire a reference feature spectrum as a feature spectrum from an output of a specific layer of the trained machine learning model, the reference data indicating a reference evaluation predetermined by the evaluation;
a second acquisition unit configured to input the target data to be evaluated to the trained machine learning model to acquire a target feature spectrum as the feature spectrum from an output of the specific layer;
a calculation unit configured to calculate a spectral similarity that is a similarity between the reference feature spectrum and the target feature spectrum; and
an evaluation unit configured to evaluate the target data using the spectral similarity.

7. A non-transitory computer-readable storage medium storing a program causing a computer to execute an evaluation of target data, the program comprising:
(a) a function of inputting a plurality of training sets to a vector neural network machine learning model having a plurality of vector neuron layers to train the machine learning model, the training sets including general-purpose training data having a type different from the target data and a label corresponding to the general-purpose training data;
(b) a function of, after executing the function (a), inputting reference data having the same type as the target data to the trained machine learning model to acquire a reference feature spectrum as a feature spectrum from an output of a specific layer of the trained machine learning model, the reference data indicating a reference evaluation predetermined by the evaluation;
(c) a function of, after executing the function (a), inputting the target data to be evaluated to the trained machine learning model to acquire a target feature spectrum as the feature spectrum from an output of the specific layer;
(d) a function of calculating a spectral similarity that is a similarity between the reference feature spectrum and the target feature spectrum; and
(e) a function of evaluating the target data using the spectral similarity.
